(19) United States
(12) Patent Application Publication
(10) Pub. No.: US 2011/0246261 A1
(43) Pub. Date: Oct. 6, 2011

(54) USER-GENERATED CONTENT POLICY OPTIMIZATION

(76) Inventors: Farhang Kassaei, San Jose, CA (US); Kenichi Akiyama, San Jose, CA (US); Wisam G. Daoud, Dublin, CA (US); Angela K. Lau, San Jose, CA (US); Snezana Sahter, San Jose, CA (US)

(21) Appl. No.: 12/752,945

(22) Filed: Apr. 1, 2010

(51) Int. Cl. G06Q 10/00; G06Q 50/00

(52) U.S. Cl. 705/7.38; 705/348

(57) ABSTRACT

A method and system for user-generated content policy optimization are described. In example embodiments, a harvester module receives listing data from a database. The listing data represents user-generated content maintained by a content serving platform, such as a network-based marketplace. An impact module calculates a compliance impact based on a profile report. The profile report includes use of elements in the listing data. A policy module analyzes the policy affecting the user-generated content.

### TECHNICAL FIELD

The subject matter disclosed herein generally relates to the field of electronic commerce. Specifically, the present disclosure addresses systems and methods of optimizing policies targeting user-generated content in a content serving platform.

### BACKGROUND

With the widespread acceptance of the Internet or other electronic communications systems as a ubiquitous, interactive communication and interaction platform, submitting and serving the user-generated content over, for example, the Internet has become commonplace in a variety of business environments, including auctions and fixed price item sales. An amount of online marketplaces is utilized by merchants as an important, if not primary, distribution channel for products. These merchants may be “power sellers” that typically list a large amount of items to be sold or auctioned by the online marketplace by submitting the user-generated content.

However, allowing end-users (e.g., merchants) to freely submit the user-generated content to a content serving platform (e.g., the online marketplace) introduces risks and, in the end, may impact both the content serving platform and the end-users. An example of a risk introduced by the user-generated content is malicious code that compromises the security of the end-users. Malicious code can impact both hardware resources and confidential information of the end-user, resulting in loss to the end-user. In another way, the threat of receiving malicious code may motivate a substantial number of the end-users to avoid using the content serving platform all together. In an online marketplace, a reduction of user-generated code has a cyclical impact on the online marketplace. In particular, a decrease in the amount of user-generated content reduces incentives for purchasers to visit the online marketplace. In turn, a decrease in the number of visits to the content serving platform reduces the incentives for a seller to place user-generated content on the content serving platform, thus continuing the cycle. These two factors can combine to result in a significant reduction in the amount of sales occurring at the online marketplace.

In order to manage user-generated content, the content serving platform may rely on rigid policies that affect all content entered into the system. Additionally, the content serving platforms may only accept user-generated content in a single form, for example, as plain text. However, these approaches only verify user-generated content at the time the end-user submits the user-generated content to the content serving platform. Moreover, the content serving platform cannot measure with confidence the impact that modifying, adding, or deleting new policies will have with respect to existing user-generated content.

### BRIEF DESCRIPTION OF DRAWINGS

Embodiments of the inventive subject matter are illustrated by way of example and not limitation in the figures of the accompanying drawings, in which like reference numbers indicate similar elements.

FIG. 1 is a network diagram depicting a client-server system, within which one example embodiment of a policy framework may be deployed.

FIG. 2 is a block diagram illustrating the policy framework as a closed loopback system in an example embodiment.

FIG. 3 is a block diagram illustrating component modules of a policy framework, according to an example embodiment.

FIG. 4 is a schema diagram illustrating a policy-targeting schema, according to an example embodiment.

FIG. 5 is a flow chart of a method of a policy-targeting method, according to various example embodiments.

FIG. 6 is a flow chart of a method of analyzing the compliance impact of a user-generated content policy, according to various example embodiments.

FIG. 7 is a flow chart of a method of determining the user-generated content policy's impact to an end-user, according to various example embodiments.

FIG. 8 is a flow chart of a method of determining the user-generated content policy's impact on the content serving platform, according to various example embodiments.

FIG. 9 is a flow chart of a method of determining the user-generated content policy's benefit to the content serving platform, according to various example embodiments.

FIGS. 10A and 10B are graphs that show example cost functions, according to various example embodiments.

FIG. 11 is a diagrammatic representation of a machine in the example form of a computer system within which a set of instructions for causing the machine to perform any one or more of the methodologies discussed herein may be executed.

### DETAILED DESCRIPTION

The description that follows includes illustrative systems, methods, and techniques that embody various aspects of the inventive subject matter discussed herein. Moreover, as used herein, the term “or” may be construed in either an inclusive or an exclusive sense. Similarly, the term “exemplary” is construed merely to mean an example of something or an exemplar and not necessarily a preferred or ideal means of accomplishing a goal.

Example systems and methods are directed at optimizing policies restricting user-generated content (UGC) in a content serving platform. In the following description, for purposes of explanation, numerous specific details are set forth in order to provide a thorough understanding of some example embodiments. It will be evident, however, to one skilled in the art that the present invention may be practiced without these specific details. Further, well-known instruction instances, protocols, structures, and techniques have not been shown in detail.

For purposes of this specification, the term “content serving platform” shall be taken to include any system capable of providing content to an end-user in response to a request for content. As an example, an online marketplace is one type of content serving platform. Other types of content serving platforms include discussion boards, blogs, comment sections of a website, and various other types of media sources.

User-generated content refers generally to content, created by an end-user, incorporated into and managed by the content serving platform. The content serving platform may be configured to manage UGC including various types of data, including text, video, audio, web documents, web code, applications, or any other type of digital data capable of being managed by a content serving platform. An online marketplace may, for example, manage listings of items for sale, submitted by an end user. The sale items may be submitted in the form of webpage content (e.g., HTML). The end-user may also submit digital media (e.g., an image file such as a JPEG file) to be included in the listing.

UGC may compose any portion of the total content managed by the content serving platform. For example, the content serving platform may only accept user submitted reviews, while the majority of the content managed by the content serving platform may be prepared by an administrator rather than end-users. Alternatively, the majority of the content managed by the content serving platform may be UGC, as in an online discussion board or an online marketplace.

The content serving platform may require that the UGC complies with a set of guidelines or policies. As an example, the content serving platform may seek to restrict UGC that violates copyright laws, uses offensive language, or uses data associated with security risks. A UGC policy generally determines whether a submitted UGC satisfies one or more guidelines or policies of the content serving platform. For example, the content serving platform may define a UGC policy that prohibits client side scripts, such as JavaScript. As such, the defined UGC policy may identify UGC that includes the <script> html tag as non-complying.

UGC policies have an impact on creators of UGC. If the policy is too restrictive, the policy may create many expenses for the creators (especially to creators contributing a large amount of UGC to the content serving platform) to modify all of their UGC. If, on the other hand, the UGC policy is too lax, the content serving platform risks security breaches, malware, cookie stealing, and ultimately loss of revenue for both the content serving platform and the end-users.

A policy framework is a set of tools, systems, artifacts, and reports that allows a content serving platform to optimize the UGC policy to achieve certain goals. The policy optimization framework may seek, for example, to minimize the amount of changes end-users need to make to comply with the UGC policy (that is, to minimize cost to sellers) or to minimize the potential loss claims of the content serving platform (and therefore maximize content serving platform revenue).

In an example embodiment, a computer-implemented system to analyze a policy affecting UGC of a content serving platform is described. Comprised within the system, a harvester module receives listing data from a database, the listing data representing the UGC of the content serving platform. Additionally, an impact module coupled to the harvester module calculates a compliance impact based on a profile report with the profile report including use of elements in the listing data. A policy module coupled to the impact module analyzes the policy affecting the UGC.

In a further example embodiment, the compliance impact is determined based on calculating an impact to an end-user to comply. The impact to the end-user to comply is based on a fixed cost to the end-user to comply with the policy and a variable cost applied to an amount of UGC submitted by the end-user.

In an example embodiment, the impact module calculates the compliance impact based on calculating a potential loss impact to the content serving platform for the policy affecting UGC. In a further exemplary embodiment, the potential loss impact is based on an average amount of revenue generated per end-user, an estimated percentage of the UGC that will remain non-compliant with the policy, and a number of impacted end-users.

In an example embodiment, the impact module calculates the compliance impact based on calculating a potential benefit of the policy. The potential benefit is based on a cost of a fraudulent UGC and an estimated percentage of UGC affected by the policy that are fraudulent.

According to some example embodiments, the policy module further modifies the policy based on a comparison between a potential benefit of the policy and a potential loss impact.

According to some example embodiments, the impact module calculates an additional compliance impact corresponding to an additional policy. The policy module modifies the additional policy, based on a comparison between the additional compliance impact corresponding to the additional policy and the compliance impact corresponding to the policy, to reduce a total compliance impact of the content serving platform.

Further details regarding the various example embodiments described above will now be discussed with reference to the figures accompanying the present specification.

### UGC Policy Platform Architecture

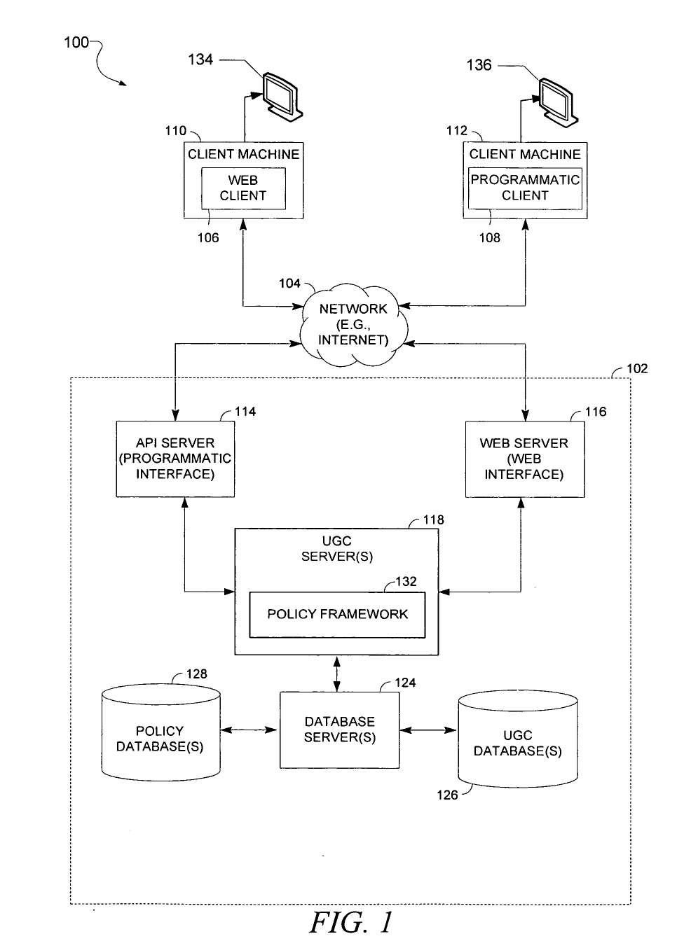

FIG. 1 is a network diagram depicting a client-server system 100, within which an example embodiment of a policy optimization engine may be deployed. A content serving platform 102, in the example, forms a network-based marketplace or publication system, provides server-side functionality, via a network 104 (e.g., the Internet or Wide Area Network (WAN)) to one or more clients. FIG. 1 is also shown to include for example, a web client 106 (e.g., a browser, such as the Internet Explorer® browser developed by Microsoft® Corporation of Redmond, Wash. State), and a programmatic client 108 executing on respective client machines 110 and 112. The client machines 110 and 112 each have an associated display device 134 and 136 (e.g., a monitor) for viewing data.

An application Program Interface (API) server 114 and a web server 116 are coupled to, and provide programmatic and web interfaces respectively to, one or more UGC servers 118. The UGC servers 118 host a policy framework 132. The UGC servers 118 are, in turn, shown to be coupled to one or more database servers 124 that facilitate access to one or more databases 126 and 128.

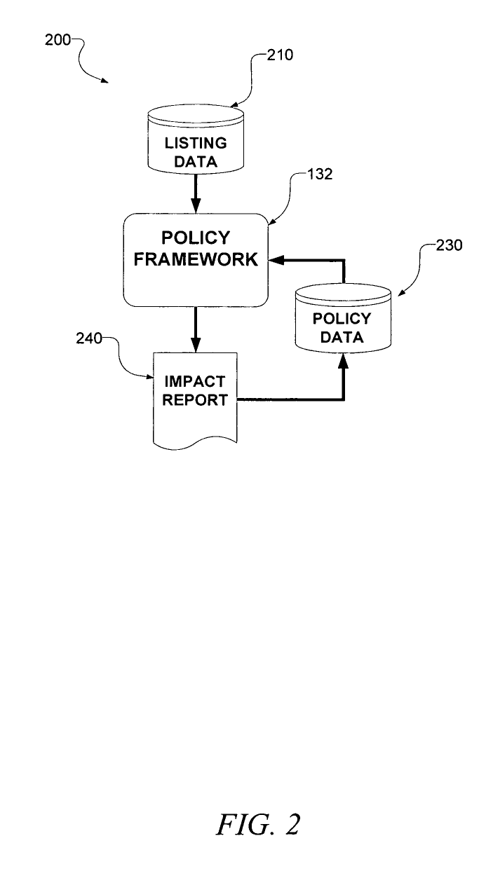

FIG. 2 is a block diagram illustrating an exemplary embodiment of the policy framework 132 as a feedback loop system 200. As shown, the policy framework 132 implements a feedback loop to optimize UGC policies. There are two inputs to the feedback loop depicted in FIG. 2, listing data 210 and policy data 230. Note that this specification may use the terms policy and UGC policy interchangeably. The listing data 210 may contain text, document files, application, HTML, CSS, JavaScript, Flash, or any other form of content or data capable of being served by a content serving platform.

The policy framework 132 processes the listing data 210, applies the policy data 230 to the listing data 210, and calculates an impact report 240. The impact report 240 may be calculated in terms of the impact to the end-user (e.g., cost for the end-user to conform UGC to the policy data 230) as well as the impact to the content serving platform 102 (see FIG. 1). Operations of the policy framework 132, including applying the policy data 230 and calculating the impact report 240, are described in greater detail, below.

In subsequent iterations of the feedback loop system 200, the policy data 230 may be analyzed and adjusted based on the impact report 240 generated by the policy framework 132. In turn, the policy framework 132 may generate further versions of the impact report 240 in response to a modified version of the policy data 230 of subsequent iterations of the feedback loop system 200. The feedback loop system 200 allows the content serving platform 102 of FIG. 1 to adjust iteratively policies to affect the compliance impact to achieve certain goals.

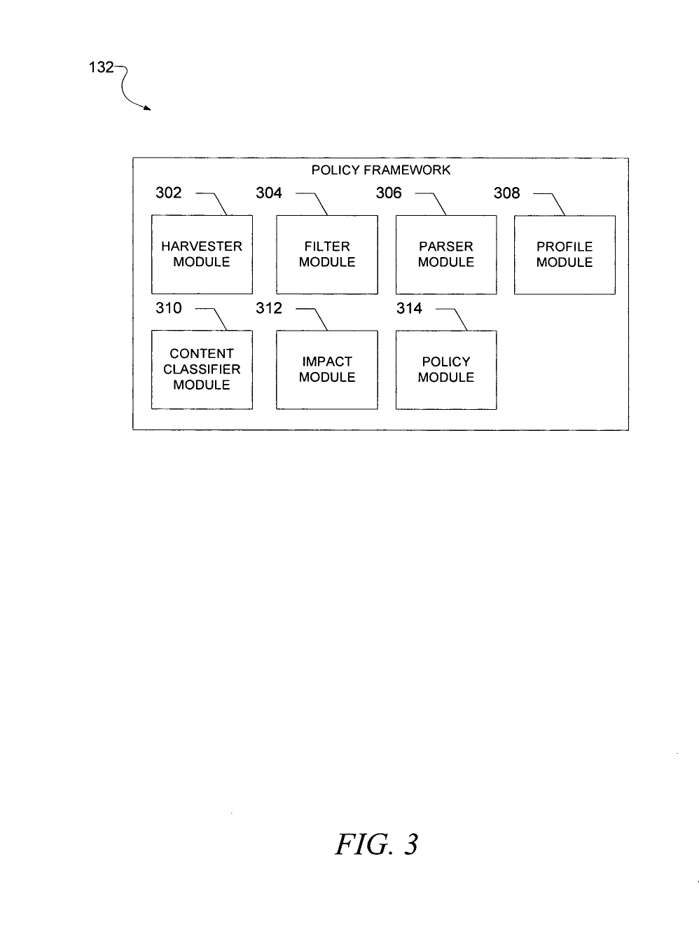

FIG. 3 is a module diagram illustrating various modules of the policy framework 132. Modules may constitute either software modules (e.g., code embodied on a machine-readable storage medium or included within a transmission signal) or hardware modules. FIG. 3 further shows the policy framework 132 including a harvester module 302, a filter module 304, a parser module 306, a profile module 308, a content classifier module 310, an impact module 312, and a policy module 314.

With concurrent reference to FIGS. 1, 2, and 3, the harvester module 302 collects the listing data 210 from, for example, the databases 126 of the content serving platform 102. In some embodiments, the harvester module 302 collects data based on constraints specified by an administrator. The specified constraints may relate to system qualities, such as scalability (e.g., maximum harvested data per run or excluded listing data from particular sites), or to UGC qualities (e.g., harvest listings satisfying a specified criteria).

The filter module 304 may be used to process UGC based on constraints specified by a user of the policy framework 132. The filter module 304 may segment the listing data 210 based on properties of the UGC, locale or site, or end-user. For example, the filter module 304 may define a segment based on whether the UGC belongs to an item category, or whether the end-user submitting the UGC meets specified conditions, such as achieving an average selling-price above, below, or equal to a defined threshold amount or attaining a monthly inventory turnover below a specified (e.g., a predetermined) amount.

The parser module 306 processes the listing data 210 into a form capable of further processing by the policy framework 132. The main function of the parser module 306 is to generate a parsing tree (e.g., a document object model (DOM) tree) for each UGC. The parsing tree then becomes a basis of subsequent processing. In some embodiments, the content classifier module 310 can process improperly formed UGC. For example, item descriptions may not be well formed or invalid according to an adopted format (e.g., an extensible markup language (XML) schema). If the UGC of the listing data 210 does not comply with the adopted format, it would be desirable for the parser module 306 to correct the UGC in a way that still allows the policy framework 132 to continue processing the UGC.

The profile module 308 profiles the listing data 210 and generates a profile report. In example embodiments, the profile report generated by the profile module 308 is based on the use of specific HTML elements in the listing data 210. For instance, the profile module 308 profiles the use of the <Table> HTML tag across the listing data 210. In other example embodiments, the profile module 308 profiles the use of the <Table> HTML tag for all UGC stored within the listing data 210 and, in other example embodiments, the profile module 308 profiles the use of tags belonging to UGC submitted by end-users from a specified segment. The profile module 308 may also profile usage of attributes of each element (e.g., align or style attributes of the <Table> tag). In short, the profile report may be a pre-processing report useful to the other modules of the policy framework 132 in generating the impact report 240.

The content classifier module 310 focuses on “higher level semantics” of a UGC and, as such, is able to answer higher level and more complex questions. To compare the difference between the profile module 308 and the content classifier module 310, the profile module 308 may answer “How many times the <script> tag appears in the listings of a power seller?,” while the content classifier module 310 may answer “How many power sellers use active scripting?” The latter requires the content classifier module 310 to understand what “active scripting” means and how it translates to basic element usage. In this case, active scripting may be defined to mean the use of <script> tag, the use of specified attributes within an element (such as onClick, on Focus, or other similar web attribute), and also the use of Flash, which in turn may mean the use of <Object> tag. In other words, the content classifier module 310 may understand and classify combinations of elements. End-users incorporate these combinations of elements to implement features called widgets. Therefore, the content classifier module 310 may recognize the widgets and other higher level constructs within UGC.

The impact module 312 calculates the impact a UGC policy has on the client-server system 100. As previously described, if a UGC policy is too restrictive, the policy creates additional expenses for sellers, especially power sellers that may need to modify a significant amount of offending UGC. If the UGC policy is too lax, the content serving platform 102 risks security breaches, malware, cookie stealing, and ultimately a potential loss of revenue. The impact module 312 calculates this impact. The impact module 312 receives the profile report generated by the profile module 308, applies the UGC policies, and calculates the number of items and end-users (e.g., sellers) that would be impacted. Based on the impact, the impact module 312 may calculate the cost impact of compliance to the end-users. Based on the UGC impacted by the policy, the impact module 312 may also calculate the potential loss impact to the content serving platform 102. Based on the impact calculated by the impact module 312, the policy framework 132 may analyze and modify the UGC policies, as facilitated by policy module 314, and measure the impact the new UGC policies has on the client-server system 100. In this way, the policy framework 132 may operate within the feedback loop system 200, shown in FIG. 2, allowing fine-tuning of the UGC policies based on the impact report 240.

Having defined a high-level approach of the policy framework 132, the remainder of the specification focuses on two additional features of UGC policy optimization. First, in order to measure the impact a UGC policy has on the client-server system 100, the impact module 312 applies the UGC policy to UGC (e.g., the listing data 210). Complicating matters, the content serving platform 102 may define a flexible approach whereby UGC policies are selectively applied to the UGC depending on the particular end-user, locale or site, or UGC generating tool. Thus, the policy framework 132 should be able to handle this flexible approach. Second, once the impact module 312 identifies the impacted UGC, the compliance impact of the policy affecting the content serving platform 102 may be determined. This may involve calculating the impact to the end-user and the positive and negative impact to the content serving platform 102.

### Policy Targeting Schema

This section of the specification further describes how the policy framework may apply UGC policies to the UGC. That is, this section focuses on the enforcement of the UGC policies. Enforcement of a UGC policy has at least two aspects. A first aspect addresses “what” is being enforced. That is, what is the nature of policy and the UGC that the end-user is submitting? This aspect is largely addressed by the definition of the UGC policy and the outputs of the profile module 308 and content classifier module 310. A second aspect answers the question of “who?” That is, the second aspect may determine (1) who (or which end-user) is submitting the UGC, (2) what tool the submitter uses, and (3) at which site or locale the submitter is located.

An example embodiment of this invention determines the second aspect, the question of who, by applying a policy targeting schema. The policy-targeting schema may define a set of valid policy targets. The policy-targeting schema may also define a hierarchy or prioritization mechanism to resolve policy conflicts, as described below.

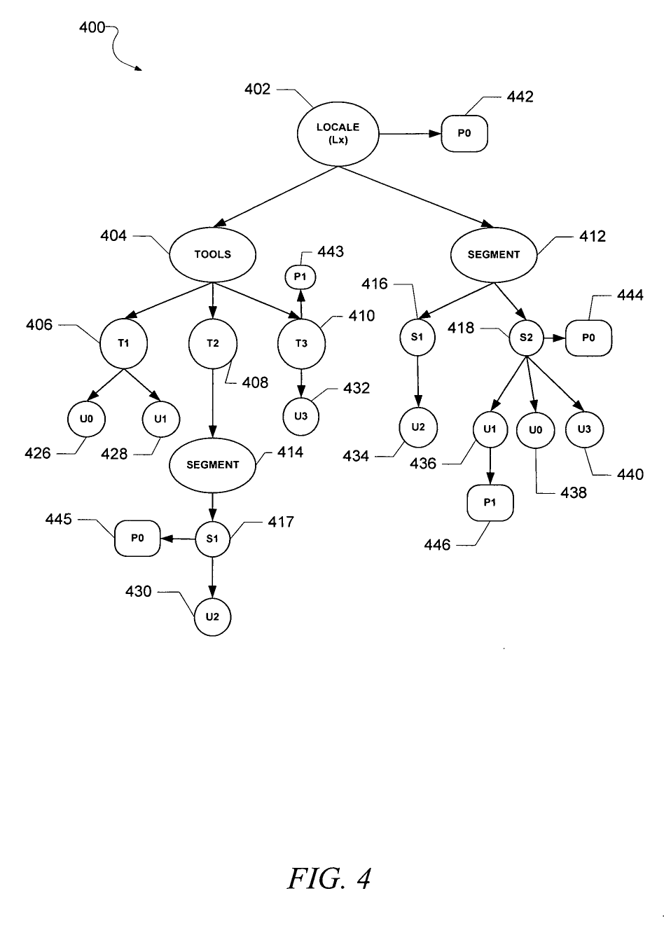

FIG. 4 is a schema diagram illustrating a policy-targeting schema 400. The policy-targeting schema 400 includes a locale schema 402. The locale schema 402 defines an individual locale or site where end-users are registered. For example, FIG. 4 shows a number of end-users 426-440 registered at the locale or site represented by the locale schema 402.

The end-users of the locale schema 402 may be organized further according to a tool schema 404 and segment schemas 412 and 414. The segment schema 412 defines a schema for all site users. FIG. 4 shows that the segment schema 412 represents a binary segmentation for the locale schema 402. As an example, in an online marketplace, segment s1 (e.g., 416 and 417) may represent those end-users (e.g., sellers) with a feedback score less than a specified score, while segment s2 (e.g., 418) may represent those end-users with a feedback score equal to or exceeding the specified score (e.g., power sellers).

Additionally, FIG. 4 also shows that segment schemas can be used to organize further tool schemas. Tool schemas define the end-users that produce UGC based on a tool (e.g., tools 406, 408, and 410). An online marketplace, for example, may provide tools to list items for sales or tools to create widgets. One such tool is the Turbo Lister™ developed by eBay® Inc. of San Jose, Calif. Segment schemas used in this way organize end-users of a particular tool. As shown in FIG. 4, tool 408 defines a segment schema 414. Segment schema 414 further includes segment 416. By way of example, segment schema 414 in an online marketplace may represent “power sellers” using a listing tool (e.g., Turbo Lister™ produced by eBay® Inc.).

The content serving platform 102 (see FIG. 1) may define one or more policies for the policy targeting schema 400. For example, the policy-targeting schema 400 may define a policy P0 as allowing all UGC and another policy P1 as prohibiting client side scripts. As FIG. 4 shows, a policy may target individual end-users (e.g., policy 446), site segments (e.g., policy 444), tools (e.g., policy 443), tool segments (e.g., policy 445), and locales or sites (e.g., policy 442).

Moreover, the policy-targeting schema 400 may define a priority schema among the possible policy targets to resolve conflicts. FIG. 4 shows that the priority schema, from highest priority to lowest priority, is defined as: end-user, tool segment, tool, locale or site segment, and locale or site. Thus, where a UGC policy targets an end-user and another policy targets a tool used by the end-user, the policy-targeting schema 400 can select the UGC policy targeting the end-user as the higher priority UGC policy.

Although the policy-targeting schema 400 defines the targets of an UGC policy, the policy-targeting schema 400 operates independently of the content of the UGC policy.

FIG. 4 illustrates only one example suitable schema for the policy framework 132 (see FIG. 3). The structure of the policy-targeting schema 400 can be varied as desired. FIG. 4 is intended only to be exemplary of one possible schema. Many other layouts exist, as would be appreciated by those skilled in the art.

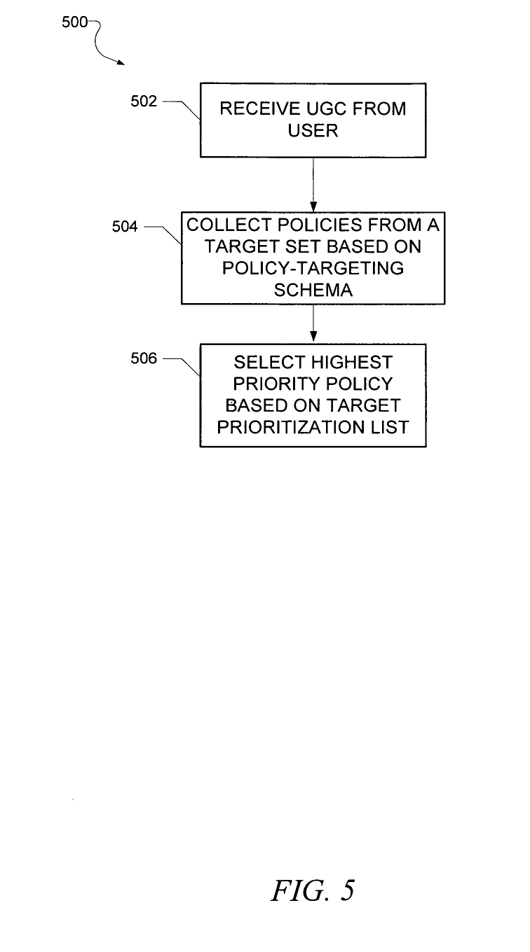

FIG. 5 is a flowchart illustrating operations in a policy-targeting method 500, according to some example embodiments. The policy-targeting method 500 is shown to include operations 502-506.

Operation 502 involves receiving UGC from an end-user. For example, the content serving platform may receive from the end-user a listing for an item that the end-user wishes to sell on the content serving platform. As described above, the listing may include text, web page tags, images, video, or any other digital content that the end-user wishes to display to potential buyers.

In an example embodiment, a request to submit UGC has the following general format: R(L, U, T, UGC), wherein R( ) represents the request to submit UGC. L represents the locale or site where the user is requesting the UGC to be submitted. U represents the end-user submitting the UGC. T represents the tool used by the end-user. From R(L, U, T, UGC), the content serving platform asks, “Which policy from the set P={p₀, p₁, . . . pₙ} should end-user U be subjected to, given U is using tool T and is attempting to submit UGC on site L?” To facilitate an answer to this question, operation 504 involves collecting policies from a target set. In an example embodiment, operation 504 may collect policies from a target set based on the policy-targeting schema 400. For example, operation 504 may traverse the policy-targeting schema 400 from the locale schema 402 to the appropriate end-user, collecting the policies targeted along the appropriate paths.

With reference again to FIG. 4, in some cases, multiple end leaves of the policy-targeting schema 400 represent the same end-user. End-users U0-U3 belong both in the locale segment schema (e.g., users 434, 436, 438, and 440) and the tools schema (e.g., tools 426, 428, 430, and 432). As such, operation 504 may identify the policies targeted along the one or more paths from the locale schema 402 to the end-user. By way of example, the policy-targeting schema 400 may identify policies P1 and P0 for user U3 based on the 402-404-410-432 path and the 402-412-418-440 path. Although the paths to user U3 is described as running from the root node (e.g., Locale 402) to the leaf node (e.g., user U3 432 and 440), a path can be described alternatively as running from a leaf node to a root node.

Referring again to FIG. 5, operation 506 involves selecting a UGC policy based on a target prioritization list. The target prioritization list selects a UGC policy among the UGC policy set. For example, with reference to FIG. 4, the valid policy set for end-user 436 is {P0, P1}, but P0 has higher priority because policy 424 targets the end-user 436. The target prioritization list may be configurable. For example, the content serving platform may configure the target prioritization list based on metadata. In other exemplary embodiments, the prioritization list may be inherent from, or embedded within, the structure of the policy-targeting schema 400.

### Calculating the Impact of UGC Policies

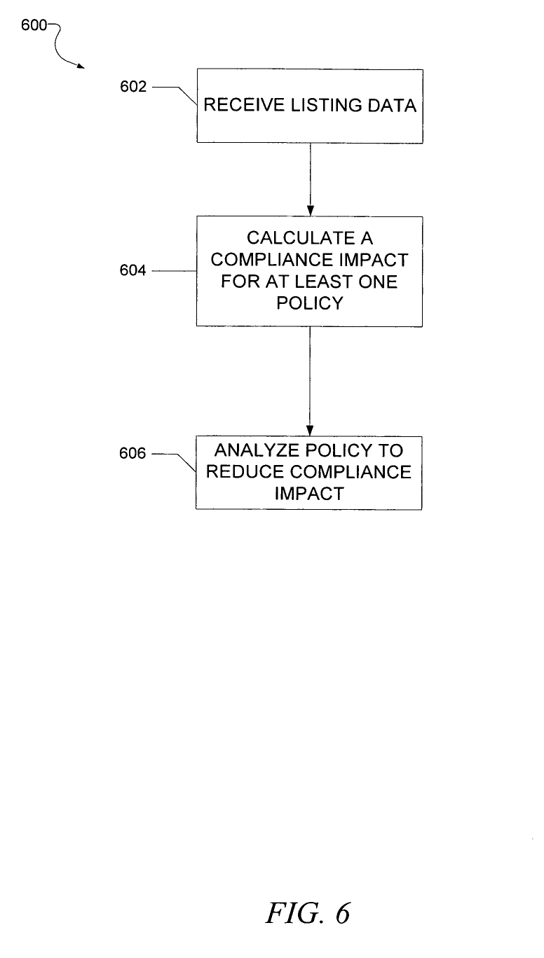

FIG. 6 is a flow diagram illustrating a method 600 of analyzing the compliance impact of a UGC policy. As shown in FIG. 2, the policy framework 132 may operate within the feedback loop system 200. In this context, method 600 may embody a single iteration of the feedback loop system 200.

At operation 602, the listing data 210 is received. With reference to FIG. 1, listing data 210 may be received by the harvester module 302 from one or more of the database(s) 126. The listing data 210 may be further processed by the profile module 308 to generate a profile report.

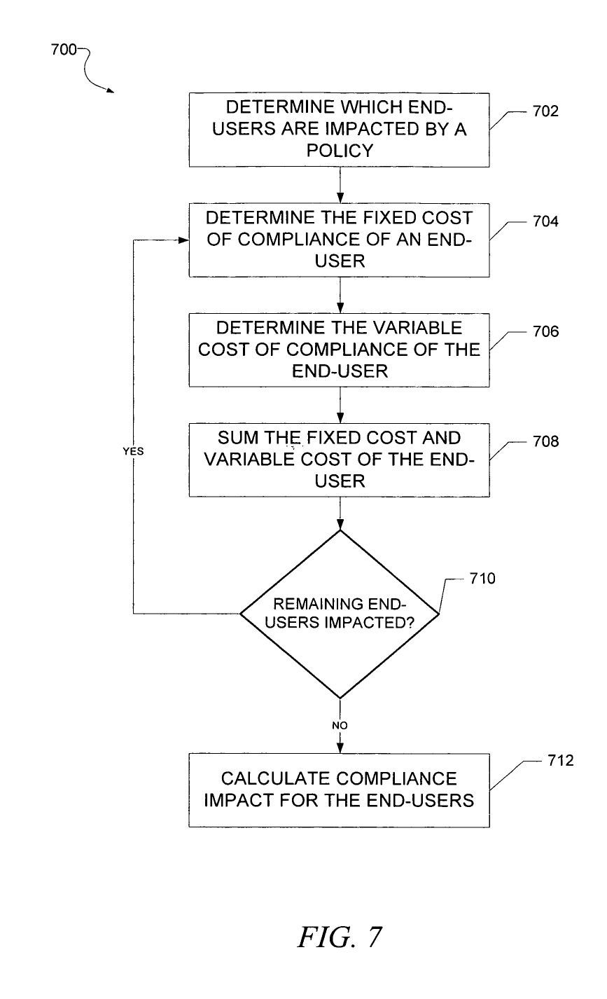

At operation 604, a compliance impact for at least one UGC policy is calculated. Calculating a compliance impact may involve determining the impact to the end-user, determining the impact to the content serving platform 102, or some combination of both. FIGS. 7-9 describe example embodiments of operation 604 in further detail. The policy framework 132 may implement one or more of the methods described therein.

At operation 606, the UGC policy is analyzed to reduce the compliance impact of the UGC policy on the UGC. The impact module 312 may generate the impact report 240 (see FIG. 2) that describes the compliance impact of the UGC policy. Depending on whether compliance impact is satisfactory, the policy module 314 may modify the UGC policy to affect the compliance impact of the UGC policy towards a desired result (e.g., to reduce the compliance impact).

Now with reference to how the impact module 312 may calculate the compliance impact, FIG. 7 shows a flow diagram illustrating a method 700 of calculating a compliance impact to the end-users for the UGC policy, in an example embodiment.

Operation 702 involves determining which end-users are impacted by the UGC policy. An example embodiment may determine impacted end-users based on the profile report generated by the profile module 308 and the policy-targeting schema 400.

Operation 704 involves determining the fixed cost of compliance for a selected end-user. An end-user's fixed cost of compliance is a cost independent of the amount of UGC associated with the end-user. Instead of being based on the amount of UGC generated by the end-user, the fixed cost depends on the segment associated with the end-user. For example, the policy framework 132(see FIG. 3) may partition end-users into a casual segment, small business segment, and medium to large business segment. The policy framework 132 may define a fixed function for each of the three segments to calculate the fixed cost to the end-user. Because the fixed cost of compliance is a constant value based on the segment of the end-user, the impact module 312 may determine the fixed cost based on the following formulas:

FixedCost(end-user)=FC1 if Seller belong to Casual Seller Group

FixedCost(end-user)=FC2 if Seller belong to Small Business Group

FixedCost(end-user)=FC3 if Seller belong to Medium and Large Group;

where FC1, FC2, and FC3 are constant values configured by the impact module 312.

Operation 706 involves determining the variable cost of compliance for the selected end-user. Unlike the fixed cost of compliance, the variable cost of compliance may depend on the amount of UGC associated with the end-user. That is, variable cost is calculated based on an economy of scale model.

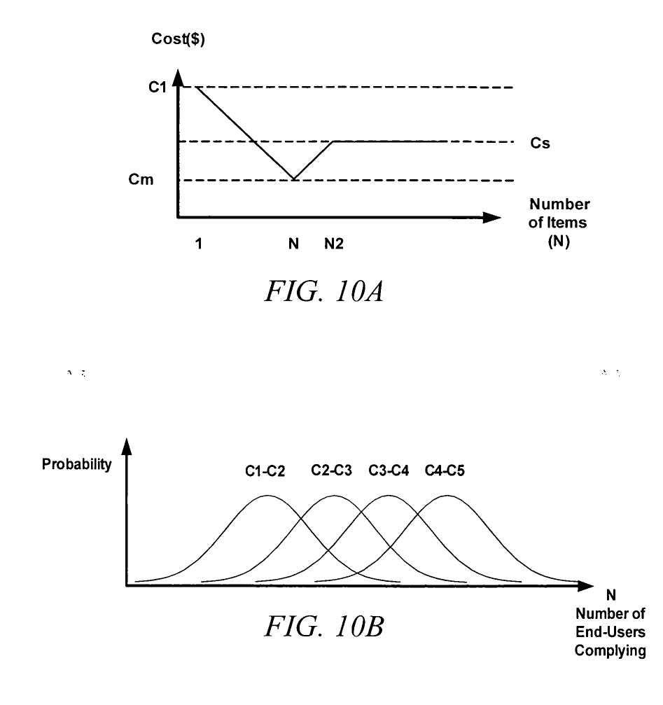

Switching focus for the moment to further describe an example variable cost function, FIG. 10A is a graph that illustrates an example variable cost function. C1 represents the cost of fixing one item. C1 may be an estimate based on the average hour wage of labor and the average time to modify the one item. If, for example, the average hourly wage is $10 and the average time to make the change is 30 minutes, C1 would equal $5.

The slope of variable cost function may also be estimated or used by the impact module 312. For example, the model shown in FIG. 10A has the following form:

if n<N2, VC=absolute(a*(n−N))+Cm

if n≧N2, VC=Cs

where n is the amount of UGC impacted for a particular end-user, a is a system parameter representing the slope of the line, and absolute( ) transforms a parameter to an absolute value. The content serving platform 102 (see FIG. 1) may continually update parameters a, Cm, N and N2.

FIG. 10A illustrates one suitable function for a variable cost function. FIG. 10A is intended only to be exemplary of one possible function. Many other functions exist as would be appreciated by those skilled in the art, and the function to calculate a variable cost can be varied as desired. For example, rather than a linear slope as shown in FIG. 10A, the slope can be expressed to be concave up or down (e.g., as described by a polynomial or exponential function). Further, the variable cost function may include multiple or no vertices.

Returning focus back to FIG. 7, operation 708 involves summing the fixed cost of compliance with the variable cost of compliance for the selected end-user. Based on the fixed and variable cost, the combined cost of compliance to the selected end-user may be calculated based on the following equation:

FixedCost(end-user)+VariableCost(end-user,n).

Operation 710 involves determining whether additional end-users are impacted by the UGC policy. In some embodiments, the impact module 312 utilizes the profile report generated by the profile module 308 (see FIG. 3) to identify additional UGC that may be impacted by the UGC policy. If there are additional end-users impacted, the method 700 performs operation 704. If not, the method 700 performs operation 712.

Operation 712 involves calculating the total compliance impact for the selected end-users. This operation may be a summation of the cost of compliance for each individual end-user identified in operations 704-708.

In this way, the method 700 measures the cost to the end-user to comply with the UGC policies of the content serving platform. That is, the cost to the end-users to modify their UGC to comply with the UGC policies defined by the content serving platform 102. However, the cost of compliance to the system as a whole may include other cost components besides just the cost to modify noncompliant UGC. In particular, end-users may decide that the cost to modify their UGC is too high and, as a result, the end-users may remove the offending UGC altogether. However, the content serving platform 102 generally benefits from the presence of UGC, and the removal thereof may impact the content serving platform 102.

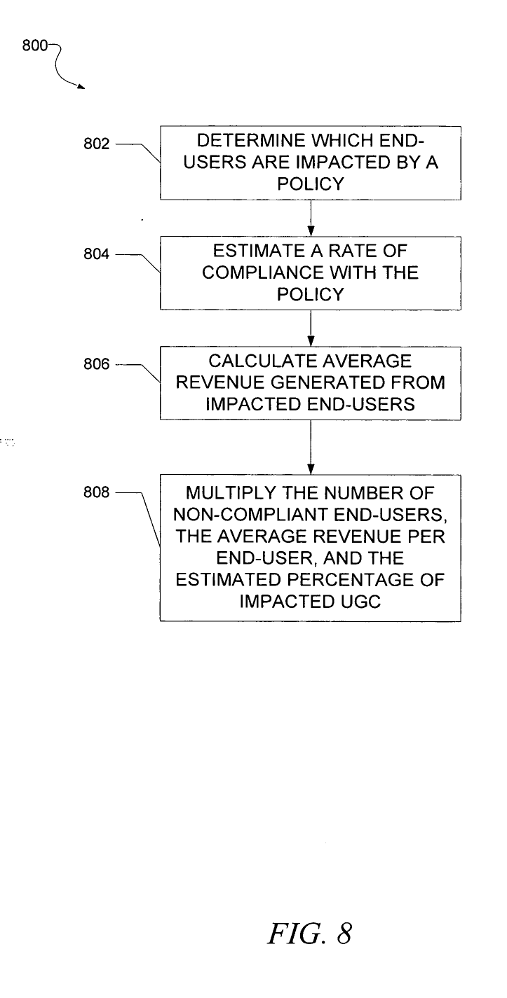

FIG. 8 is a method diagram illustrating a method 800 of determining the impact of compliance to the content serving platform. Similar to operation 702 shown in FIG. 7, operation 802 involves determining which end-users are impacted by a UGC policy.

Operation 804 involves estimating a rate of compliance with the UGC policy. The rate of compliance represents the rate or likelihood that an end-user will modify offending UGC to comply with the UGC policy. Because offending UGC is not served by the content serving platform, a 95% compliance rate results in a 5% reduction in UGC managed by the content serving platform. As previously described, a reduction in the amount of UGC maintained by the content serving platform 102 may negatively impact the profits of the content serving platform 102.

The impact module 312 of FIG. 3 may estimate a rate of compliance for each end-user segment. In other exemplary embodiments, a rate of compliance is estimated for each end-user. Still, in other embodiments, a common rate of compliance may be generated globally for all end-users and all segments. In some example embodiments, the impact module 312 may estimate the rate of compliance responsive to historical data.

Referring again to FIG. 8, operation 806 involves calculating the average revenue generated from impacted end-users. In particular, operation 806 may calculate the estimated revenue generated by an end-user in each segment per item. As with the estimated rate of compliance, exemplary embodiments may calculate the average revenue generated from impacted end-users at various levels of granularity. For example, operation 806 may calculate the average revenue generated for each end-user, for each segment, or globally for all end-users.

Operation 808 involves calculating the loss to the content serving platform based on operations 804 and 806. For example, the loss to the content serving platform may be calculated based on the following calculation:

Cost=N_{end-user}*(1−ComplianceRate)*Revenue(end-user);

where N_{end-user} represents the number of impacted end-users. As described above, compliance rate could be estimated on an end-user, segment, or global basis. Further, revenue can also be based on similar levels of specificity.

As described above, the method 800 is an exemplary embodiment that calculates the cost to the content serving platform based on estimates of the rate of compliance and average revenue per UGC. Another exemplary embodiment may calculate the cost to the content serving platform based on probabilistic techniques. In particular, the calculation is based on confidence intervals. To illustrate, consider the probabilistic technique as sending a survey out to a number of end-users and asking, “Given that it will cost end-user $X to comply with the policy, would end-user make the changes to comply?” and counting the number of end-users who respond affirmatively.

Instead of sending out a survey, the content serving platform 102 may use a family of normal distributions. As the graph shown in FIG. 10B indicates, a cost interval Cx-Cy corresponds to a normal distribution.

Referring once again to FIG. 3, once the impact module 312 calculates the number of end-users that will likely comply based on the appropriate normal distribution associated with the cost interval, calculating the cost impact to the impact module 312 may be based on the average revenue per item per end-user segment.

In addition to calculating the cost to the content serving platform associated with an UGC policy, the impact module 312 may also calculate the benefit of adopting the UGC policy to the content serving platform. A UGC policy benefits the content serving platform when it, for example, prevents fraud. The prevention of fraud, in turn, improves the end-user experience. The UGC policy benefit may be viewed or measured as an estimated amount of currency that the content serving platform saves due to enforcing the UGC policy.

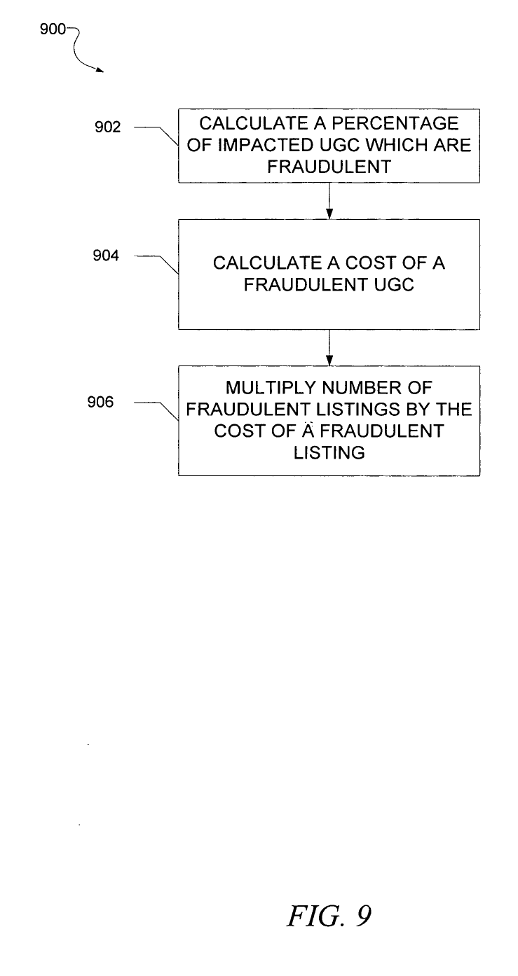

FIG. 9 is a flow diagram depicting a method 900 of calculating the benefit of a UGC policy. Operation 902 involves calculating a percentage of impacted UGC that is fraudulent. The percentage of fraudulent, impacted UGC may be based on historic fraud data maintained by the impact module 312. Alternatively, the percentage of fraudulent, impacted UGC may be estimated to be some small percentage because the amount of impacted UGC that is fraudulent is generally a small percentage of the amount of impacted UGC. Operation 904 involves calculating a cost of a fraudulent UGC. As with the percentage of fraudulent, impacted UGC, the cost of fraudulent UGC is an estimate maintained by the content serving platform.

Operation 906 involves multiplying the amount of fraudulent UGC by the cost of a fraudulent listing. The product of the amount of fraudulent UGC and the cost of a fraudulent listing estimates the cost to the content serving platform for not applying the UGC policy. In other words, operation 906 estimates the cost savings to the content serving platform for applying the UGC policy to listing data 210.

FIGS. 5-9 are flow charts of methods according to some example embodiments. While operations of these methods are described above as being performed by specific components, modules or systems of the client-server system 100, it will be appreciated that these operations need not necessarily be performed by the specific components identified, and could be performed by a variety of components and modules, potentially distributed over a number of machines. Alternatively, at least certain ones of the variety of components and modules described herein can be arranged within a single hardware, software, or firmware component.

### Example Machine Architecture and Machine-Readable Storage Medium

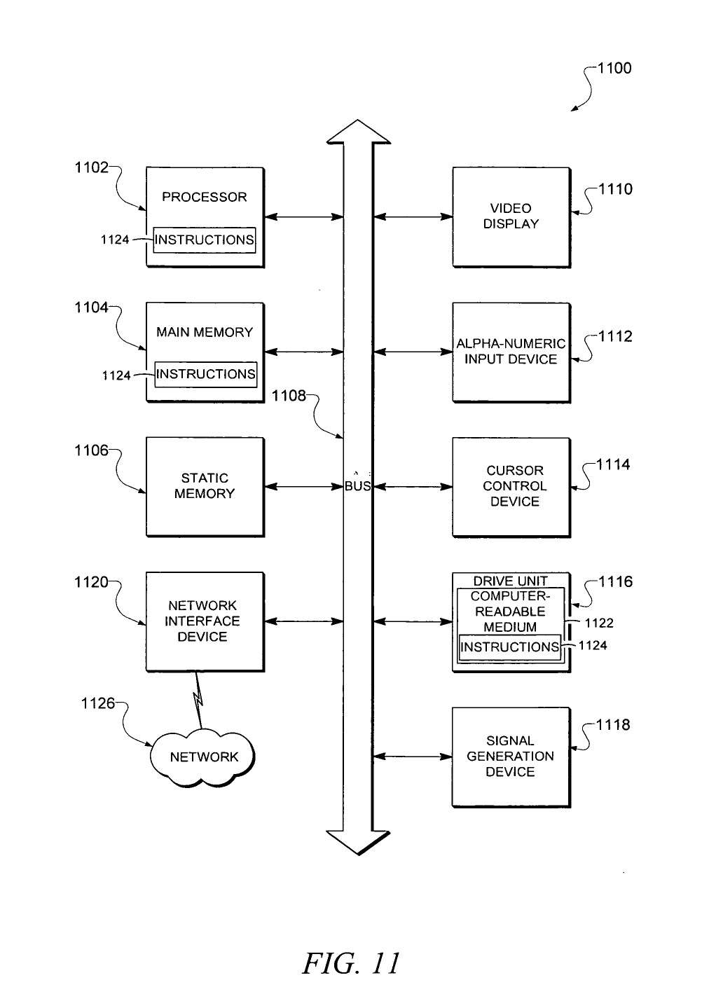

FIG. 11 is a block diagram of a machine in the example form of a computer system 1100 within which instructions for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or client devices in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1100 includes a processor 1102 (e.g., a central processing unit (CPU), a graphics processing unit (GPU) or both), a main memory 1104 and a static memory 1106, which communicate with each other via a bus 1108. The computer system 1100 may further include a video display unit 1110 (e.g., a liquid crystal display (LCD) or a cathode ray tube (CRT)). The computer system 1100 also includes an alphanumeric input device 1112 (e.g., a keyboard), a user interface (UI) navigation device 1114 (e.g., a mouse), a disk drive unit 1116, a signal generation device 1118 (e.g., a speaker) and a network interface device 1120.

### Machine-Readable Storage Medium

The disk drive unit 1116 includes a machine-readable storage medium 1122 on which is stored one or more sets of instructions 1124 and data structures (e.g., software) embodying or utilized by any one or more of the methodologies or functions described herein. The instructions 1124 may also reside, completely or at least partially, within the main memory 1104 or within the processor 1102 during execution thereof by the computer system 1100, the main memory 1104 and the processor 1102 also constituting machine-readable media.

While the machine-readable storage medium 1122 is shown in an example embodiment to be a single medium, the term “machine-readable storage medium” may include a single medium or multiple media (e.g., a centralized or distributed database, and/or associated caches and servers) that store the one or more instructions or data structures. The term “machine-readable storage medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable storage medium” shall accordingly be taken to include, but not be limited to, solid-state memories and optical and magnetic media. Specific examples of machine-readable storage media include non-volatile memory, including by way of example, semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and CD-ROM and DVD-ROM disks.

### Transmission Medium

The instructions 1124 may further be transmitted or received over a communications network 1126 using a transmission medium. The instructions 1124 may be transmitted using the network interface device 1120 and any one of a number of well-known transfer protocols (e.g., Hypertext Transfer Protocol (HTTP)). Examples of communication networks include a local area network (LAN), a wide area network (WAN), the Internet, mobile telephone networks, Plain Old Telephone Service (POTS) networks, and wireless data networks (e.g., WiFi and WiMax networks). The term “transmission medium” shall be taken to include any intangible medium that is capable of storing, encoding, or carrying instructions for execution by the machine, and includes digital or analog communications signals or other intangible medium to facilitate communication of such software.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation, and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors); these operations being accessible via a network (e.g., the Internet) and via one or more appropriate interfaces (e.g., Application Program Interfaces (APIs)).

Although certain specific example embodiments are described herein, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments are described and illustrated in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to limit voluntarily the scope of this application to any single invention or inventive concept, if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A computer-implemented system to analyze a policy affecting user-generated content of a content serving platform, the system comprising:
a harvester module to receive listing data from a database, the listing data representing the user-generated content of the content serving platform;
an impact module coupled to the harvester module to calculate, using one or more processors, a compliance impact based on a profile report, the profile report including a use of elements in the listing data; and
a policy module coupled to the impact module to analyze the policy affecting the user-generated content.

2. The system of claim 1, wherein the impact module is to calculate the compliance impact based on calculating an impact to an end-user to comply, the impact to the end-user to comply being based on a fixed cost to the end-user to comply with the policy and a variable cost applied to an amount of the user-generated content submitted by the end-user.

3. The system of claim 1, wherein the impact module is to calculate the compliance impact based on calculating a potential loss impact to the content serving platform for the policy affecting the user-generated content.

4. The system of claim 3, wherein the potential loss impact is based on an average revenue generated per end-user, an estimated percentage of the user-generated content that will remain non-compliant with the policy, and a number of impacted end-users.

5. The system of claim 1, wherein the policy module is further to modify the policy affecting the user-generated content to reduce the compliance impact.

6. The system of claim 1, wherein the impact module is to calculate the compliance impact based on calculating a potential benefit of the policy, the potential benefit being based on a cost of a fraudulent user-generated content and an estimated percentage of user-generated content affected by the policy that is fraudulent.

7. The system of claim 1, wherein the policy module is further to modify the policy based on a comparison between a potential benefit of the policy and a potential loss impact.

8. The system of claim 1, wherein:
the impact module is to calculate an additional compliance impact corresponding to an additional policy; and
the policy module is to modify the additional policy, based on a comparison between the additional compliance impact corresponding to the additional policy and the compliance impact corresponding, to the policy to reduce a total compliance impact of the content serving platform.

9. The system of claim 1, further comprising:
a filtering module to filter the listing data according to a plurality of constraints on the user-generated content;
a parsing module to parse the listing data and generate a parse tree; and
a profiler module to create the profile report from the parse tree.

10. A computer-implemented method to analyze a policy affecting user-generated content of a content serving platform, the method comprising:
receiving listing data from a database, the listing data representing the user-generated content;
calculating, using one or more processors, a compliance impact based on a profile report, the profile report including use of elements in the listing data; and
analyzing the policy affecting the user-generated content.

11. The method of claim 10, wherein the calculating of the compliance impact includes determining an impact to an end-user to comply, the impact to the end-user to comply being based on a fixed cost to the end-user to comply with the policy and a variable cost depending on an amount of the user-generated content submitted by the end-user.

12. The method of claim 10, wherein calculating the compliance impact includes determining a potential loss impact to the content serving platform for the policy affecting the user-generated content.

13. The method of claim 12, wherein determining the potential loss impact to the content serving platform is based on an average revenue generated per end-user, an estimated percentage of end-users who will not comply with the policy, and a number of the end-users impacted by the policy.

14. The method of claim 10, further comprising modifying the policy affecting the user-generated content to reduce a potential loss impact.

15. The method of claim 10, wherein calculating the compliance impact includes determining a potential benefit of the policy, the potential benefit being based on a cost of a fraudulent version of the user-generated content and an estimated percentage of the user-generated content affected by the policy which are fraudulent.

16. The method of claim 10, further comprising modifying the policy based on a comparison of a potential benefit of the policy and a potential loss impact.

17. The method of claim 10, further comprising:
calculating an additional compliance impact corresponding to an additional policy; and
modifying the additional policy to reduce a total compliance impact of the content serving platform, the modifying the additional policy being based on a comparison between the additional compliance impact and the compliance impact.

18. The method of claim 10, further comprising:
filtering the listing data according to a plurality of constraints on the user-generated content;
parsing the listing data to generate a parse tree; and
creating the profile report from the parse tree.

19. A machine-readable storage medium embodying instructions which, when executed by a machine, causes the machine to execute a method comprising:
receiving listing data from a database, the listing data representing user-generated content (UGC) of a content serving platform;
calculating, using one or more processors, a compliance impact based on a profile report, the profile report including use of elements in the listing data; and
analyzing the policy affecting the user-generated content.

20. The machine-readable storage medium of claim 19, wherein the method further further comprises:
calculating an additional compliance impact corresponding to an additional policy; and
modifying the additional policy to reduce a total compliance impact of the content serving platform, the modifying the additional policy being based on a comparison between the additional compliance impact and the compliance impact.
